(19) United States
(12) Patent Application Publication
(10) Pub. No.: US 2021/0107385 A1
(43) Pub. Date: Apr. 15, 2021

(54) VIBRATION DAMPING SYSTEM FOR VEHICLE

(71) Applicant: Toyota Jidosha Kabushiki Kaisha, Toyota-shi Aichi-ken (JP)

(72) Inventor: Ken Kuretake, Susono-shi (JP)

(21) Appl. No.: 17/069,241

(22) Filed: Oct. 13, 2020

(30) Foreign Application Priority Data
Oct. 15, 2019 (JP) 2019-188417

(51) Int. Cl. B60N 2/50; B60N 2/52

(52) U.S. Cl. CPC B60N 2/501; B60N 2/502; B60N 2/525

(57) ABSTRACT

A vibration damping system configured to improve ride quality as well as controllability and stability of a vehicle. The vibration damping system is applied to a vehicle comprising a vehicle body suspension, and a seat suspension including a spring and a damper. The vibration damping system is configured to: estimate acceleration of a sprung seat mass and a resonance frequency when vibrations propagates to the sprung seat mass; calculate a target value of the acceleration of the sprung seat mass; and set a spring constant of the spring and a damping coefficient of the damper to values possible to achieve the target value of the acceleration of the sprung seat mass, before the vibrations propagate to the sprung seat mass.

### CROSS REFERENCE TO RELATED APPLICATIONS

The present disclosure claims the benefit of Japanese Patent Application No. 2019-188417 filed on Oct. 15, 2019 with the Japanese Patent Office, the disclosure of which are incorporated herein by reference in its entirety.

### BACKGROUND

### Field of the Disclosure

Embodiments of the present disclosure relate to the art of a vibration damping system for a vehicle configured to suppress vibrations propagating from wheels and a chassis to a seat.

### Discussion of the Related Art

JP-A-S63-8009 describes an active suspension for maintaining posture of a vehicle while improving ride quality by absorbing vibrations propagating from a road surface. The active suspension taught by JP-A-S63-8009 comprises: a hydraulic cylinder arranged between a vehicle body and a wheel; a pressure control valve that regulates an operating pressure of the hydraulic cylinder; a throttle valve and an accumulator that generate damping force to absorb vibrations corresponding to resonance frequency of an unsprung mass; a posture change detecting means that detects a change in posture of the vehicle; and a posture change preventing device. Specifically, the hydraulic accumulator is connected to a hydraulic chamber of the hydraulic cylinder through the throttle valve, and the posture change preventing device absorbs vibrations corresponding to resonance frequency of a sprung mass by controlling the pressure control valve in accordance with a change in posture of the vehicle. According to the teachings of JP-A-S63-8009, vibration damping characteristics of the throttle valve is set in such a manner as to satisfy the following inequality “F₁/V₁≤F₂/V₂” where V₁ is a piston speed of the hydraulic cylinder corresponding to vibrations around the resonance frequency of the unsprung mass, F₁ is a vibration damping force corresponding to vibrations around the resonance frequency of the unsprung mass, V₂ is a piston speed of the hydraulic cylinder corresponding to vibrations around the resonance frequency of the sprung mass, and F₂ is a vibration damping force corresponding to vibrations around the resonance frequency of the sprung mass.

JP-A-2019-48489 A1 describes a suspension mechanism arranged between a seat and a vehicle body to support the seat. In the suspension mechanism taught by JP-A-2019-48489 A1, an upper suspension is overlapped on a lower suspension, and a frame of the upper suspension and a frame of the lower suspension are connected to each other through linkage mechanisms and springs while being allowed to reciprocate relatively to each other in a vertical direction. A force to reciprocate those frames of the upper suspension and the lower suspension is damped by damper mechanisms. According to the teachings of JP-A-2019-48489 A1, characteristics of one of the damper mechanisms or springs is changed from that of the other one of the damper mechanisms or springs to cause a phase difference between motions of suspensions.

Thus, according to the teachings of JP-A-S63-8009, the resonance frequency of the sprung mass governing passenger comfort of the seat, and the resonance frequency of the unsprung mass governing controllability of the vehicle are reduced by the hydraulic cylinder and the hydraulic accumulator. According to the teachings of JP-A-S63-8009, specifically, undesirable posture change of the vehicle such as nose diving, rolling, pitching or the like is suppressed by controlling working pressure of the hydraulic cylinder so as to reduce vibrations of the sprung mass. In addition, in order to improve ride quality by absorbing unevenness of the road surface, the throttle valve is tuned to satisfy the inequality “F₁/V₁≤F₂/V₂”.

However, since the road condition changes continuously during propulsion, it is not easy to improve both of the controllability and the ride quality of the vehicle only by the active suspension taught by JP-A-S63-8009. That is, although the ride quality is improved by tuning the throttle valve of the hydraulic accumulator by the above-explained manner, vibrations may not be absorbed properly by the hydraulic accumulator if the road condition varies significantly more than expected. In principle, the ride quality of a vehicle can be improved by softening the suspension. However, if the suspension of the vehicle is too soft, the controllability may be reduced. By contrast, controllability of a vehicle can be improved by hardening the suspension. However, if the suspension of the vehicle is too hard, the ride quality may be reduced.

### SUMMARY

Aspects of embodiments of the present disclosure have been conceived noting the foregoing technical problems, and it is therefore an object of the present disclosure to provide a vibration damping system configured to improve ride quality as well as controllability and stability of a vehicle.

The vibration damping according to the exemplary embodiment of the present disclosure is applied to a vehicle, comprising: a vehicle body suspension that absorbs and damps vibrations propagating between an axle and a chassis of the vehicle; a seat suspension including a spring and a damper that absorb and damp vibrations propagating between the chassis and a seat, in which a spring constant of the spring and a damping coefficient of the damper are variable; and a detector that obtains information relating to a running condition of the vehicle. In order to achieve the above-explained objective, the vibration damping system is provided with a controller that controls the seat suspension based on the information obtained by the detector. The information obtained by detector includes: an acceleration of an unsprung vehicle mass below the vehicle body suspension; an acceleration of a sprung vehicle mass above the vehicle body suspension; an acceleration of an unsprung seat mass below the seat suspension; and an acceleration of a sprung seat mass above the seat suspension. Specifically, the controller is configured to: estimate the acceleration of the sprung seat mass and a resonance frequency when the vibrations resulting from change in the acceleration of the unsprung vehicle mass propagates to the sprung seat mass via the sprung vehicle mass and the unsprung seat mass, based on the information obtained by the detector; calculate a target value of the acceleration of the sprung seat mass possible to reduce an actual value of the acceleration of the sprung seat mass while preventing an occurrence of resonance, by changing the estimate values of the acceleration of the sprung seat mass; and set the spring constant of the spring and the damping coefficient of the damper to values possible to achieve the target value of the acceleration of the sprung seat mass, before the vibrations propagate to the sprung seat mass.

In a non-limiting embodiment, the controller may be further configured to: calculate a change rate of the acceleration of the sprung seat mass and a local maximum value of the change rate of the acceleration of the sprung seat mass; and update the target value of the acceleration of the sprung seat mass to an estimate value of the acceleration of the sprung seat mass at a time point when the change rate of the acceleration of the sprung seat mass is increased to the local maximum value.

In a non-limiting embodiment, the controller may be further configured to: calculate a difference between the actual value and the target value of the acceleration of the sprung seat mass during propulsion of the vehicle; determine whether the difference between the actual value and the target value of the acceleration of the sprung seat mass is greater than a predetermined lower limit value but less than a predetermined upper limit value, and whether the difference between the actual value and the target value of the acceleration of the sprung seat mass has fallen continuously within a range between the predetermined lower limit value and the predetermined upper limit value for a predetermined period of time; and update the target value of the acceleration of the sprung seat mass to the actual value of the acceleration of the sprung seat mass at an end point of the predetermined period of time, if the difference between the actual value and the target value of the acceleration of the sprung seat mass has fallen continuously within the range between the predetermined lower limit value and the predetermined upper limit value for the predetermined period of time.

In a non-limiting embodiment, the controller may be further configured to: calculate a difference between the actual value and the target value of the acceleration of the sprung seat mass while the vehicle is stopping; determine whether the difference between the actual value and the target value of the acceleration of the sprung seat mass calculated within a predetermined period of time immediately before cancelling a brake force applied to the vehicle is greater than a predetermined lower limit value but less than a predetermined upper limit value; and update the target value of the acceleration of the sprung seat mass to the actual value of the acceleration of the sprung seat mass at a point when the brake force applied to the vehicle is eliminated, if the difference between the actual value and the target value of the acceleration of the sprung seat mass calculated within the predetermined period of time is greater than the predetermined lower limit value but less than the predetermined upper limit value.

In a non-limiting embodiment, the vehicle may comprise a plurality of the separated seats. The chassis may include the sprung vehicle mass and the unsprung seat mass, and the seat suspension may be arranged individually between the chassis and each of the seats. In addition, the controller may be further configured to control each of the seat suspension individually.

In a non-limiting embodiment, the vehicle may comprise a plurality of the separated seats, and a floor member to which the seats are fixed. The chassis may include the sprung vehicle mass and the unsprung seat mass. The seat suspension may be arranged between the chassis and the floor member.

In a non-limiting embodiment, the chassis may comprise: an axle supporting section as the sprung vehicle mass that supports the axle through the vehicle body suspension; and an underbody section as the unsprung seat mass that supports the seat through the seat suspension. A first chassis spring constant of an elastic member of the axle supporting section is greater than a second chassis spring constant of an elastic member of the underbody section.

In a non-limiting embodiment, the chassis may comprise: an axle supporting section as the sprung vehicle mass that supports the axle through the vehicle body suspension; and an underbody section as the unsprung seat mass that supports the seat through the seat suspension. Rigidities of the axle supporting section and the underbody section may be changed respectively by changing a first chassis spring constant of an elastic member of the axle supporting section and a second chassis spring constant of an elastic member of the underbody section. In addition, the controller may be further configured to control the rigidities of the axle supporting section and the underbody section such that the actual value of the acceleration of the sprung seat mass is reduced.

In a non-limiting embodiment, the seat suspension may comprise a pair of the springs arranged in a lateral direction of the vehicle. The detector may be configured to detect a displacement or vibrations of the vehicle in a rolling direction, and the controller may be further configured to control each of the springs individually to suppress the displacement or vibrations of the vehicle in the rolling direction.

In a non-limiting embodiment, the seat suspension may comprise a pair of the springs arranged in a longitudinal direction of the vehicle. The detector may be configured to detect a displacement or vibrations of the vehicle in a pitching direction, and the controller may be further configured to control each of the springs individually to suppress the displacement or vibrations of the vehicle in the pitching direction.

Thus, the vehicle to which the vibration damping system according to the exemplary embodiment of the present disclosure is applied is provided with an active seat suspension in which a spring constant and a damping coefficient are variable. In the vehicle, vibrations derived from unevenness of a road surface propagate to the sprung seat mass through the vehicle body suspension, the chassis, and the seat suspension with an inevitable delay. According to the exemplary embodiment of the present disclosure, in order to damp the vibrations propagate to the sprung seat mass, the spring constant and the damping coefficient of the seat suspension are adjusted to values possible to damp the vibrations before the vibrations propagates to the unsprung vehicle mass. According to the exemplary embodiment of the present disclosure, therefore, an occurrence of resonance can be prevented when the vibrations propagate to the sprung seat mass. In this situation, rigidity of the vehicle body suspension is maintained so that a vertical load applied to a tire is maintained sufficiently to prevent posture change of the vehicle. According to the exemplary embodiment of the present disclosure, therefore, not only ride quality of the vehicle but also controllability and stability of the vehicle may be improved.

When the vehicle travels on a bumpy road, the tires bounce on the road surface intermittently. In this situation, accelerations of the unsprung vehicle mass and the sprung vehicle mass are changed significantly and detection values of the acceleration will be varied significantly. Consequently, a target value of the acceleration of the sprung seat mass may not be set accurately and the vibrations may not be damped effectively. In order to avoid such disadvantage, according to the exemplary embodiment of the present disclosure, an estimate value of the acceleration of the unsprung vehicle mass or the sprung vehicle mass at the point when a change rate of the acceleration of the sprung seat mass is increased to the local maximum value is employed as the target value of the acceleration of the sprung seat mass. Consequently, the target value of the acceleration of the sprung seat mass may be set accurately based on the estimate value of the sprung seat mass which is estimated accurately while eliminating the influence of detection error. According to the exemplary embodiment of the present disclosure, therefore, the vibrations of the sprung seat mass can be damped effectively while preventing an occurrence of resonance even when the vehicle travels on a rough road.

When the vehicle travels on a slope, a detection error of the acceleration may also be increased by a road grade, and an accuracy of setting the target value of the acceleration of the sprung seat mass may be reduced. In order to avoid such disadvantage, if a difference between the target value and the actual value (i.e., the detection error) of the acceleration of the sprung vehicle mass has fallen continuously within the range between the lower limit value and the upper limit value for the predetermined period of time, the target value of the acceleration of the sprung vehicle mass is updated. Consequently, the target value of the acceleration of the sprung seat mass may be set accurately based on the estimate value of the sprung seat mass which is estimated accurately while eliminating the influence of detection error. According to the exemplary embodiment of the present disclosure, therefore, the vibrations of the sprung seat mass can be damped effectively while preventing an occurrence of resonance even when the vehicle travels on a slope.

When a brake force applied to the vehicle is eliminated to launch the vehicle stopping on a slope, a detection error of the acceleration may also be increased by a road grade, and an accuracy of setting the target value of the acceleration of the sprung seat mass may be reduced. In order to avoid such disadvantage, if the difference between the actual value and the target value (i.e., the detection error) of the acceleration of the sprung seat mass calculated within the predetermined period of time immediately before cancelling the brake force falls within the predetermined range, the target value of the acceleration of the sprung vehicle mass is updated. Consequently, the target value of the acceleration of the sprung seat mass may be set accurately based on the estimate value of the sprung seat mass which is estimated accurately while eliminating the influence of detection error. According to the exemplary embodiment of the present disclosure, therefore, the vibrations of the sprung seat mass can be damped effectively while preventing an occurrence of resonance even when the launching vehicle stopping on a slope.

The vibration damping system according to the exemplary embodiment of the present disclosure may be applied to the vehicle in which the seat suspension is arranged individually between the chassis and each of the seats. That is, the vibration damping system according to the exemplary embodiment of the present disclosure may be applied to a conventional vehicle without modifying a structure of the vehicle. In addition, the vibrations of each seat may be damped effectively by the vibration damping system.

The vibration damping system according to the exemplary embodiment of the present disclosure, may also be applied to the vehicle in which the seat suspension is arranged individually between the floor member on which the seats are mounted and each of the seats. According to the exemplary embodiment of the present disclosure, therefore, vibrations of all of the seats may be damped integrally. In addition, a number of the seat suspensions may be reduced compared to a case of arranging the seat suspensions for each of the seats.

In the vehicle to which the vibration damping system according to the exemplary embodiment of the present disclosure is applied, the chassis includes the sprung vehicle mass and the unsprung seat mass, and the first chassis spring constant of the elastic member of the axle supporting section is greater than the second chassis spring constant of the elastic member of the underbody section. That is, rigidity of the axle supporting section is higher than rigidity of the underbody section. According to the exemplary embodiment of the present disclosure, therefore, the vertical load applied to the tire is ensured to improve controllability and stability of the vehicle. In addition, the vibrations propagating to the sprung seat mass may be further delayed so that the vibration damping effect is improved to further improve ride quality of the vehicle.

In the vehicle to which the vibration damping system according to the exemplary embodiment of the present disclosure is applied, the first chassis spring constant of the elastic member of the axle supporting section and the second chassis spring constant of the elastic member of the underbody section are variable. According to the exemplary embodiment of the present disclosure, for example, magnetic fluid is buried in each of the axle supporting section and the underbody section. In the chassis, therefore, the rigidities of the axle supporting section and the underbody section may be controlled electrically by controlling condition of the magnetic fluid using an electric magnet. For example, during normal propulsion, not only controllability and stability but also ride quality of the vehicle may be improved by setting the rigidity of the axle supporting section higher than the rigidity of the underbody section. In addition, when the running condition of the vehicle is changed, the rigidities of the axle supporting section and the underbody section may be changed arbitrarily in such a manner as to damp the vibrations effectively.

As described, the springs of the seat suspension may be arranged in the lateral direction of the vehicle. In this case, rolling of the vehicle may be suppressed by controlling each of the springs of the seat suspension individually.

As described, the springs of the seat suspension may be arranged in the longitudinal direction of the vehicle. In this case, pitching of the vehicle may be suppressed by controlling each of the springs of the seat suspension individually.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a schematic illustration showing one example of a structure of a vehicle to which the vibration damping system according to the exemplary embodiment of the present disclosure is applied, and a control system thereof;

FIG. 2 is a schematic illustration showing another example of a structure of a vehicle to which the vibration damping system according to the exemplary embodiment of the present disclosure is applied;

FIG. 3 is a schematic illustration showing another example of a structure of the control system;

FIG. 4 is a perspective view showing another example of a structure of a seat suspension;

FIG. 5 is a perspective view showing still another example of a structure of the seat suspension;

FIG. 6 is a perspective view showing yet another example of a structure of the seat suspension;

FIG. 7 is a schematic illustration showing still another example of a structure of the vehicle to which the vibration damping system according to the exemplary embodiment of the present disclosure is applied, and the control system thereof;

FIG. 8 is a block diagram showing one example of transmission of a command signal in the control system of the vehicle;

FIG. 9 is a graph indicating a relation between vibration level and resonance frequencies;

FIG. 10 is a flowchart showing one example of a basic routine executed by the vibration damping system according to the exemplary embodiment of the present disclosure;

FIG. 11 is a time chart showing a delay in propagation of the vibrations;

FIG. 12 is a map for determining propagation time of the vibrations based on a rise time of acceleration of the unsprung vehicle mass and a vehicle speed;

FIG. 13 is a graph showing a relation among a vibration transmissibility and a spring constant of the seat suspension, and a resonance frequency;

FIG. 14 is a flowchart showing one example of a specific routine executed to damp the vibrations taking account of a road grade;

FIG. 15 is a time chart showing one example of temporal changes in acceleration of the sprung seat mass and a road grade;

FIG. 16 is a flowchart showing another example of a specific routine executed to damp the vibrations taking account of an unevenness of a road surface;

FIG. 17 is a time chart showing one example of a temporal change in the acceleration of the sprung vehicle mass or the unsprung vehicle mass, and a temporal change in the change rate of the acceleration of the sprung seat mass;

FIG. 18 is a schematic illustration showing one example of a structure of the chassis;

FIG. 19a is a schematic illustration showing another example of a structure of the chassis;

FIG. 19b is a schematic illustration showing a structure of an axle supporting section of the chassis of FIG. 19a;

FIG. 20 is a schematic illustration showing another example of a structure of the seat; and

FIG. 21 is a schematic illustration showing still another example of a structure of the seat.

### DETAILED DESCRIPTION OF THE EMBODIMENTS

Embodiments of the present disclosure will now be explained with reference to the accompanying drawings.

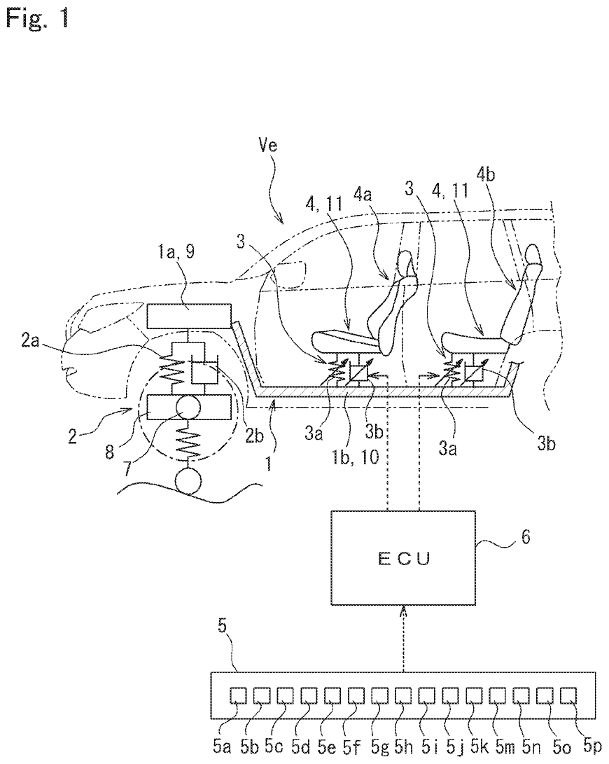

Turning now to FIG. 1, there is shown one example of a structure of a vehicle Ve to which the vibration damping system is applied. The vehicle Ve comprises a chassis 1, a vehicle body suspension 2, a seat suspension 3, a seat 4, a detector 5, and a controller 6 as an electronic control unit.

A prime mover (not shown) and the seat 4 are mounted on a chassis 1 as a frame of the vehicle Ve, and the vehicle body suspension 2 is attached to the chassis 1. According to exemplary embodiment of the present disclosure, the chassis 1 includes a body-on frame on which a vehicle body is mounted, a monocoque chassis in which the frame is integrated with the vehicle body, and a complex chassis in which sider frames are arranged on both sides of the monocoque chassis. The chassis 1 comprises an axle supporting section 1a and an underbody section 1b.

Specifically, an upper portion of the vehicle body suspension 2 is attached to the axle supporting section 1a of the chassis 1, and a lower portion is attached to an axle 7 connected to a pair of wheels (not shown). Accordingly, a sprung vehicle mass 9 includes the axle supporting section 1a supporting the axle 7 connected to the wheels through the vehicle body suspension 2. On the other hand, an unsprung vehicle mass 8 includes the axle 7 and a predetermined member supporting the axle 7.

A lower portion of the seat suspension 3 is attached to the underbody section 1b of the chassis 1, and an upper portion of the seat suspension 3 is attached to the seat 4. That is, the seat 4 is arranged on the underbody section 1b of the chassis 1 while being supported by the seat suspension 3. Accordingly, an unsprung seat mass 10 includes the underbody section 1b, and a sprung seat mass 11 includes the seat 4.

Thus, vibrations propagating from tires (not shown) to the chassis 1 via the axle 7 are damped and suppressed by the vehicle body suspension 2. As the conventional suspensions, the vehicle body suspension 2 comprises a spring 2a and a damper 2b illustrated schematically as a vibration model in FIG. 1.

On the other hand, vibrations propagating from the chassis 1 to the seat 4 are damped and suppressed by the seat suspension 3. The seat suspension 3 comprises an air spring 3a, and a damper 3b. In order to absorb the vibrations propagating from the chassis 1 to the seat 4, a spring constant of the air spring 3a is variable. For example, the spring constant of the air spring 3a may be changed by changing an internal pressure or (i.e., a volume) of air compressed in an air cylinder or an air tank (neither of which are shown). On the other hand, for example, an electromagnetic damper may be adopted as the damper 3b, and a damping coefficient (or factor) of the damper 3b is also variable electromagnetically. Instead, a hydraulic damper may also be adopted as the damper 3b, and in this case, a damping coefficient of the damper 3b may be changed by changing an internal pressure or (i.e., a volume) of oil compressed in a hydraulic cylinder or an oil tank (neither of which are shown). In FIG. 1, the seat suspension 3 is also illustrated schematically as a vibration model.

The seat 4 on which a drive or a passenger sits includes a separate seat and a bench seat. According to the exemplary embodiment of the present disclosure, the seat 4 includes a front seat 4a and a rear seat 4b. Specifically, the front seat 4a includes a driver seat and a passenger seat, and the rear seat 4b includes at least one passenger seat. The front seat 4a and the rear seat 4b are individually attached to the chassis 1 through the seat suspension 3. That is, according to the exemplary embodiment of the present disclosure, the seat suspensions 3 supporting the front seat 4a and the rear seat 4b are controlled individually.

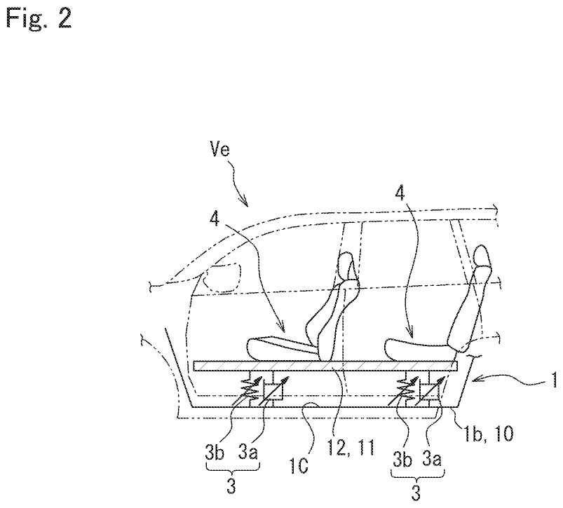

Optionally, as illustrated in FIG. 2, a floor member 12 as a plate member having a predetermined rigidity may be arranged between the seat 4 and the chassis 1, in addition to a floor panel 1c fixed to the chassis 1. In this case, the front seat 4a and the rear seat 4b are mounted on the floor member 12, and the floor member 12 is fixed to the chassis 1 or the floor panel 1c through the seat suspensions 3. That is, according to the example shown in FIG. 2, the sprung seat mass 11 includes the floor member 12 to which the front seat 4a and the rear seat 4b are fixed, and the seat suspensions 3 are controlled individually. According to the example shown in FIG. 2, therefore, the vibrations propagating to the front seat 4 and the rear seat 4 may be damped by controlling the seat suspensions 3 integrally. In addition, a number of the seat suspensions 3 may be reduced compared to the case of arranging the seat suspensions 3 for each of the seats 4.

The detector 5 is configured to detect and calculates data relating to running conditions of the vehicle Ve required to executing the vibration damping control. According to the exemplary embodiment of the present disclosure, the detector 5 comprises: an acceleration sensor 5a that detects vertical acceleration of the unsprung vehicle mass 8 below the vehicle body suspension 2; an acceleration sensor 5b that detects vertical acceleration of the sprung vehicle mass 9 above the vehicle body suspension 2; an acceleration sensor 5c that detects vertical acceleration of the unsprung seat mass 10 below the seat suspension 3; an acceleration sensor 5d that detects vertical acceleration of the sprung seat mass 11 above the seat suspension 3; an acceleration sensor 5e that detects longitudinal acceleration of the seat 4; an acceleration sensor 5f that detects lateral acceleration of the seat 4; a displacement sensor 5g that detects vertical displacement of the seat 4; a wheel speed sensor 5h that detects a vehicle speed; an accelerator sensor 5i that detects a position of an accelerator pedal (not shown); a brake switch sensor 5j that detects a depression of a brake pedal (not shown), a brake pressure sensor 5k that detects a hydraulic pressure in a master cylinder of a brake device (not shown); a speed sensor 5m that detects an output speed of a prime mover (not shown); a steering sensor 5n that detects a steering angle of a steering device (not shown); a laser sensor 5o that detects unevenness of a road in front of the vehicle Ve by a laser beam; and a navigation system 5p that obtains positional information with reference to a map database.

The controller 6 comprises a microcomputer as its main constituent, and for example, the air spring 3a and the damper 3b of the seat suspension 3 are controlled by the controller 6. To this end, data obtained by the detector 5 is sent to the controller 6, and the controller 6 performs a calculation based on the data transmitted from the detector 5, and data and formulas stored in the controller 6. A calculation result is transmitted from the controller 6 in the form of command signal to control e.g., the air spring 3a and the damper 3b so as to reduce the vibrations.

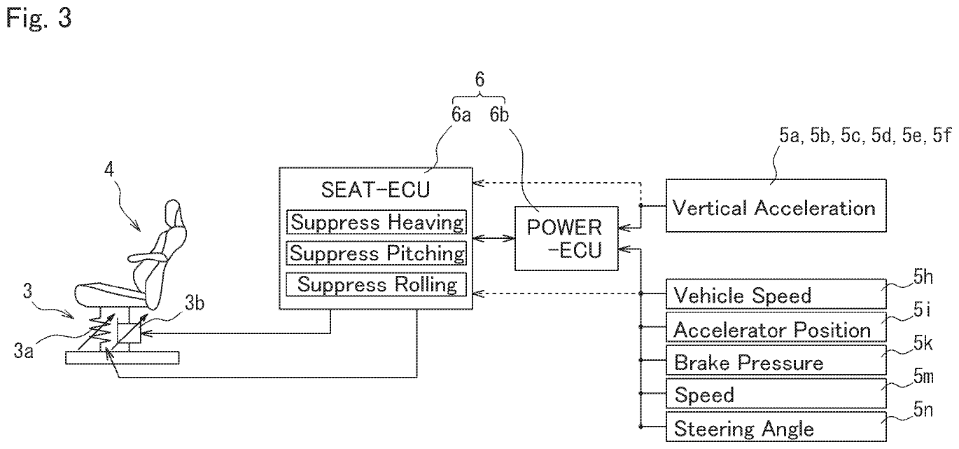

Although only one controller 6 is depicted in FIG. 1, a plurality of controllers may be arranged in the vehicle Ve to control the specific devices individually. For example, according to the example shown in FIG. 3, the controller 6 comprises a seat/suspension controller (referred to as “SEAT-ECU” in FIG. 3) 6a, and a power controller (referred to as “POWER-ECU” in FIG. 3) 6b.

The seat/suspension controller 6a is configured to control the air spring 3a and the damper 3b of the seat suspension 3 based on the data transmitted thereto from the detector 5.

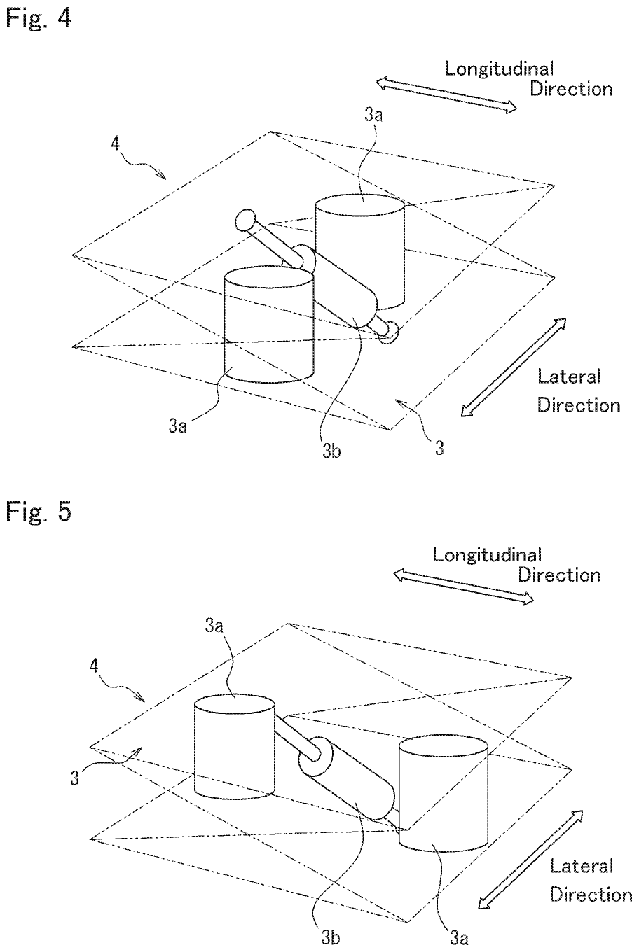

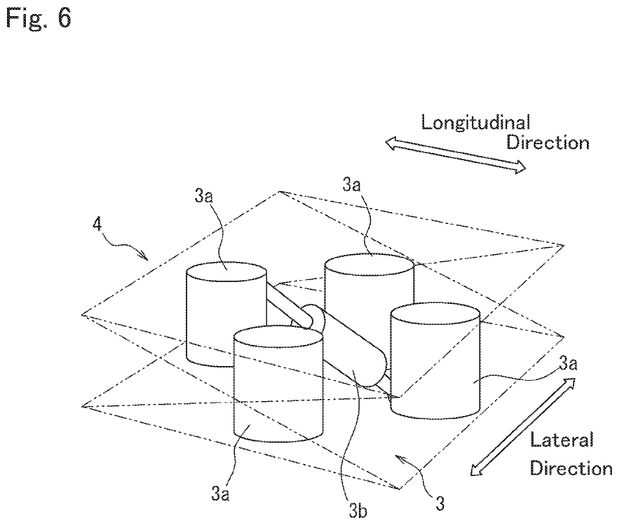

For example, as illustrated in FIG. 4, the seat suspension 3 may comprise a plurality of the air springs 3a arranged in the lateral direction of the vehicle Ve, and the seat/suspension controller 6a controls the air springs 3a in such a manner as to reduce rolling of the vehicle Ve based on a detection value transmitted from the steering sensor 5n.

As illustrated in FIG. 5, the air springs 3a may also be arranged in the longitudinal direction of the vehicle Ve. In this case, the seat/suspension controller 6a controls the air springs 3a in such a manner as to reduce pitching of the vehicle Ve based on detection values transmitted from the accelerator sensor 5i and the brake pressure sensor 5k.

Further, the seat suspension 3 may comprise a pair of the air springs 3a arranged in the longitudinal direction and a pair of the air springs 3a arranged in the lateral direction. In this case, the seat/ suspension controller 6a controls the air springs 3a in such a manner as to reduce not only pitching and rolling of the vehicle Ve but also heaving (or bouncing) of the vehicle Ve, based on detection values transmitted from the steering sensor 5n, the accelerator sensor 5i, and the brake pressure sensor 5k.

On the other hand, the power controller 6b controls the prime mover and the brake device based on the information transmitted from the detector 5. For example, the power controller 6b controls an output power of the prime mover based on a required drive force calculated based on a detection value transmitted form the accelerator sensor 5i, and a detection value transmitted from the wheel speed sensor 5h. In addition, the power controller 6b also controls the brake device based on a detection value transmitted from the brake pressure sensor 5k. That is, the power controller 6b controls a drive force to propel the vehicle Ve and a brake force applied to the vehicle Ve. In order to reduce the vibrations effectively, according to the exemplary embodiment of the present disclosure, the seat suspensions 3 and the drive force as well as the brake force are controlled cooperatively by the seat/suspension controller 6a and the power controller 6b.

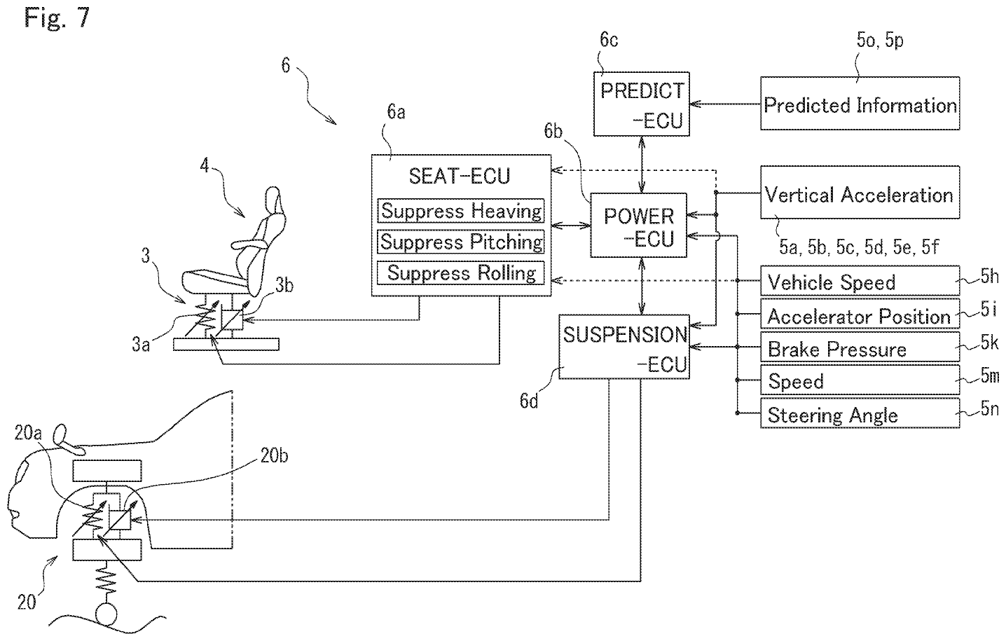

As shown in FIG. 7, the controller 6 may further comprise a prediction controller (referred to as “PREDICT-ECU” in FIG. 7) 6c. In order to control the air spring 3a and the damper 3b in advance, the prediction controller 6c transmits command signals to the seat/suspension controller 6a based on the information transmitted from the laser sensor 5o and the navigation system 5p. For example, the seat suspensions 3 may be controlled more effectively to damp the vibrations by utilizing a road condition in front of the vehicle Ve predicted in advance by the laser sensor 5o and the navigation system 5p.

In addition, as also illustrated in FIG. 7, an active body suspension 20 may also be employed instead of the vehicle body suspension 2. As shown in FIG. 7, the active body suspension 20 comprises an air spring 20a and a damper 20b. In order to absorb the vibrations propagating from the axle 7 to the chassis 1, a spring constant of the air spring 20a may be changed by changing an internal pressure or (i.e., a volume) of air compressed in an air cylinder or an air tank (neither of which are shown). On the other hand, for example, an electromagnetic damper may be adopted as the damper 20b, and in order to absorb the vibrations propagating from tires (not shown) to the chassis 1 via the axle 7, a damping coefficient (or factor) of the damper 2b is also variable electromagnetically. Instead, a hydraulic damper may also be adopted as the damper 20b, and in this case, a damping coefficient of the damper 20b may be changed by changing an internal pressure or (i.e., a volume) of oil compressed in a hydraulic cylinder or an oil tank (neither of which are shown).

In the vehicle Ve shown in FIG. 7, the controller 6 further comprises a body suspension controller (referred to as “SUSPENSION-ECU” in FIG. 7) 6d that controls the air spring 20a and the damper 20b of the active body suspension 20. In order to reduce the vibrations effectively, according to the example shown in FIG. 7, the seat suspensions 3 and the active body suspension 20 are controlled cooperatively by the seat/suspension controller 6a and the suspension controller 6d.

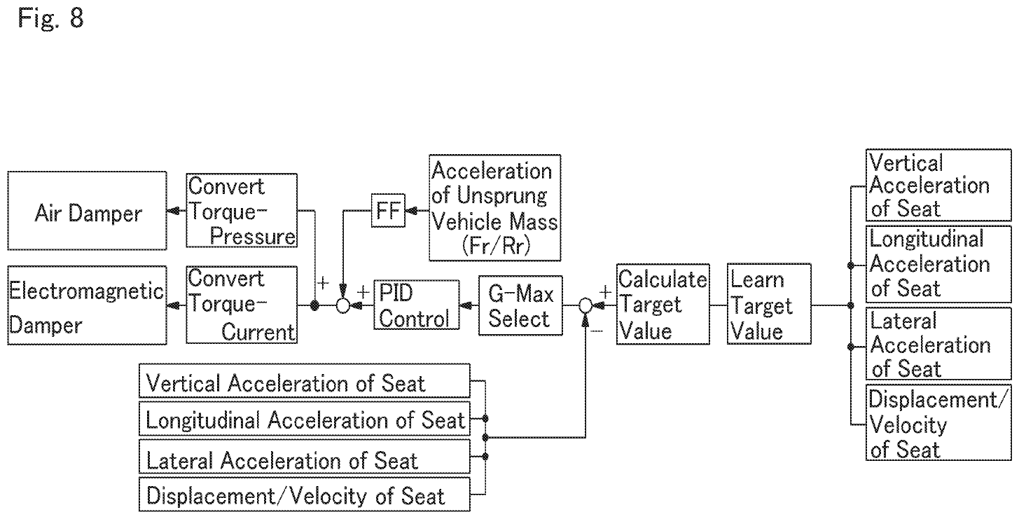

As shown in FIG. 8, the controller 6 computes target values of vertical acceleration of the seat 4 (i.e., the sprung seat mass 11), longitudinal acceleration of the seat 4, lateral acceleration of the seat 4, vertical displacement (or displacement velocity) of the seat 4 and so on based on detection (or actual) values transmitted from the detector 5. Then, the controller 6 computes a difference between the target value and the actual value of each of those accelerations. Here, priorities of the above-mentioned acceleration values may be set, and the above-mentioned acceleration values may be employed selectively in the vibration damping control in order of priority. Instead, a maximum value of the acceleration may be employed in the vibration damping control (G-Max select).

Thereafter, control objects (e.g., the air spring 3a and the electromagnetic damper as the damper 3b) are controlled by a feedback method so as to adjust the actual values the above-mentioned accelerations and displacement of the seat 4 detected by the sensors to the target values. According to the example shown in FIG. 8, specifically, the control objects are controlled by the Proportional-Integral-Derivative (to be abbreviated as “PID” hereinafter) control method. In addition, the air spring 3a and the damper 3b of the seat suspension 3 are also controlled by a feed forward method. For example, the air spring 3a and the damper 3b are controlled in such a manner as to eliminate an expected difference between the target value and the actual value of the above-mentioned accelerations and displacement of the seat 4 in advance, based on the information predicted by the laser sensor 5o and the navigation system 5p.

Likewise, the air spring 20a and the electromagnetic damper 20b of the active body suspension 20 shown in FIG. 7 are also controlled by the feedback method as the above-explained procedures to control the seat suspension 3.

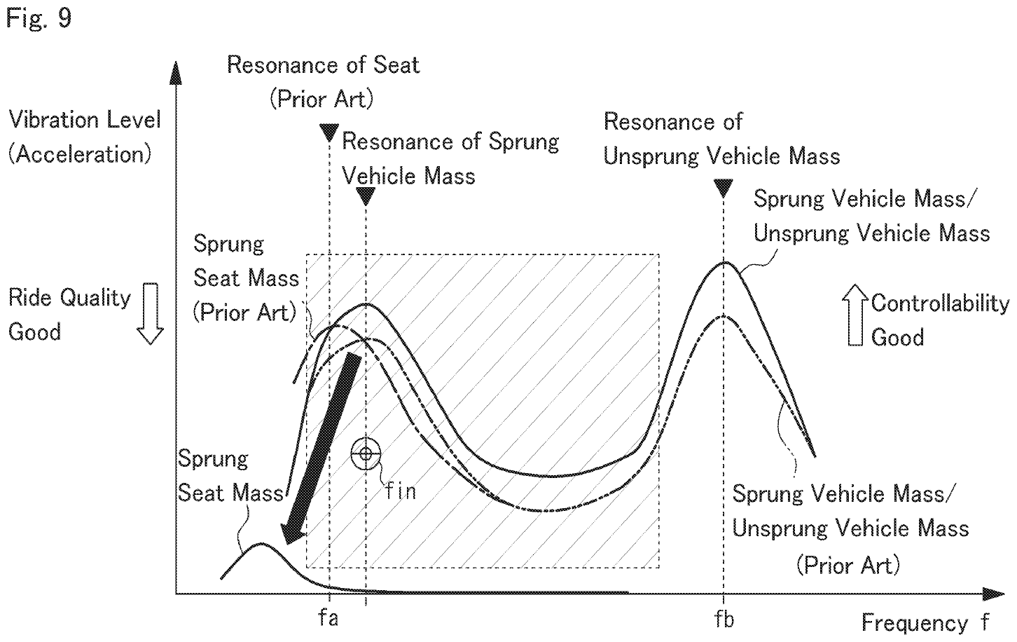

As described, according to the conventional art, it is not easy to improve the ride quality of the vehicle while improving controllability and stability of the vehicle. As illustrated in FIG. 9, given that the vehicle Ve travels on a bumpy road surface, the unsprung vehicle mass 8, the sprung vehicle mass 9 (or the unsprung seat mass 10), and the sprung seat mass 11 resonate with a vibrational input fᵢₙ of predetermined low-frequency in the vicinity of frequency Fa. In this situation, the unsprung vehicle mass 8 and the sprung vehicle mass 9 also resonate within predetermined high-frequency range in the vicinity of frequency Fb. In the high-frequency range, a vertical load applied to the tire is increased with an increase in vibration level or vertical acceleration of the resonating mass, and consequently the controllability of the vehicle Ve is improved. In FIG. 9, the hatched region is a vibration range where the vibrations offend passenger, and as indicated in FIG. 9, the unsprung vehicle mass 8 and the sprung vehicle mass 9 resonate outside the hatched region in the high-frequency range. Therefore, the ride quality of the vehicle Ve will not be reduced significantly even if the unsprung vehicle mass 8 and the sprung vehicle mass 9 resonate in the high-frequency range. By contrast, the resonances of the unsprung vehicle mass 8, the sprung vehicle mass 9, and the sprung seat mass 11 in the low-frequency range occur within the hatched region. That is, if the sprung seat mass 11 resonates in the low-frequency range, the ride quality of the vehicle Ve will be reduced.

If the suspensions of the vehicle are softened, the ride quality of the vehicle can be improved. However, the resonance in the high-frequency range is also suppressed thereby reducing the vertical load applied to the tire, and consequently the ride quality will be reduced. By contrast, if the suspensions are hardened, controllability and stability of the vehicle may be improved, but the resonance in the low-frequency range will be increased to reduce the ride quality.

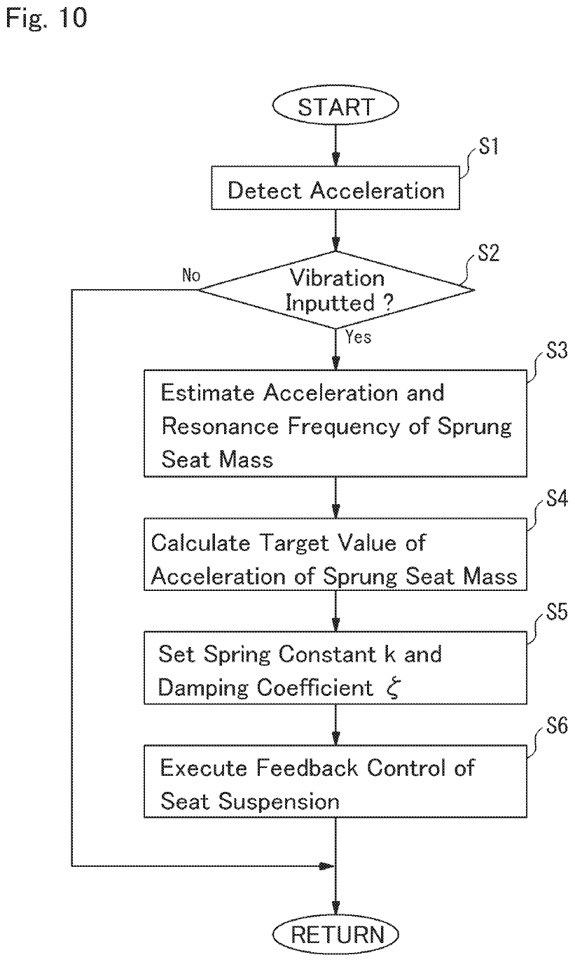

In order to improve not only ride quality of the vehicle Ve but also controllability and stability of the vehicle Ve, the vibration damping system according to the exemplary embodiment of the present disclosure executes the routine shown in FIG. 10. Specifically, the controller 6 is configured to control the air spring 3a and the damper 3b of the seat suspension 3 in such a manner as to lower the resonance frequency of the sprung seat mass 11 as indicated by the arrow in FIG. 9, and to lower vibrating level of the resonating sprung seat mass 11.

At step S1, accelerations of the unsprung vehicle mass 8, the sprung vehicle mass 9, the unsprung seat mass 10, and the sprung seat mass 11 are detected by the acceleration sensor 5a, the acceleration sensor 5b, the acceleration sensor 5c, and the acceleration sensor 5d, and detection values are sent to the controller 6.

Then, it is determined at step S2 whether the sprung seat mass 11 is vibrated by a change in the acceleration of the unsprung vehicle mass 8. For example, in order to determine whether vibrations which may reduce the ride quality of the vehicle Ve propagate from the tires to the chassis 1, it is determined at step S2 whether a change in the acceleration of the sprung seat mass 11 within a predetermined period of time is greater than a predetermined change amount. To this end, those threshold values such as the predetermined period of time and the predetermined change amount are set in advance based on results of a running test and a simulation.

If the change in the acceleration of the sprung seat mass 11 within the predetermined period of time is less than the predetermined change amount, that is, if the vibrations which may reduce the ride quality of the vehicle Ve do not propagate to the chassis 1 so that the answer of step S2 is NO, the routine returns without carrying out any specific control. By contrast, if the change in the acceleration of the sprung seat mass 11 within the predetermined period of time is greater than the predetermined change amount, that is, if the vibrations which may reduce the ride quality of the vehicle Ve propagate to the chassis 1 so that the answer of step S2 is YES, the routine progresses to step S3.

At step S3, the acceleration and the resonance frequency of the sprung seat mass 11 are estimated. As described, the sprung seat mass 11 is vibrated by the vibrations resulting from a change in the acceleration of the unsprung vehicle mass 8, and the vibrations propagate to the sprung seat mass 11 via the sprung vehicle mass 9 and the unsprung seat mass 10. At step S3, therefore, the acceleration and the resonance frequency of the sprung seat mass 11 which is presumed to be vibrated by such change in the acceleration of the unsprung vehicle mass 8 are estimated. Further, a magnitude of the resonance (i.e., vibration level) is also obtained in addition to the resonance frequency.

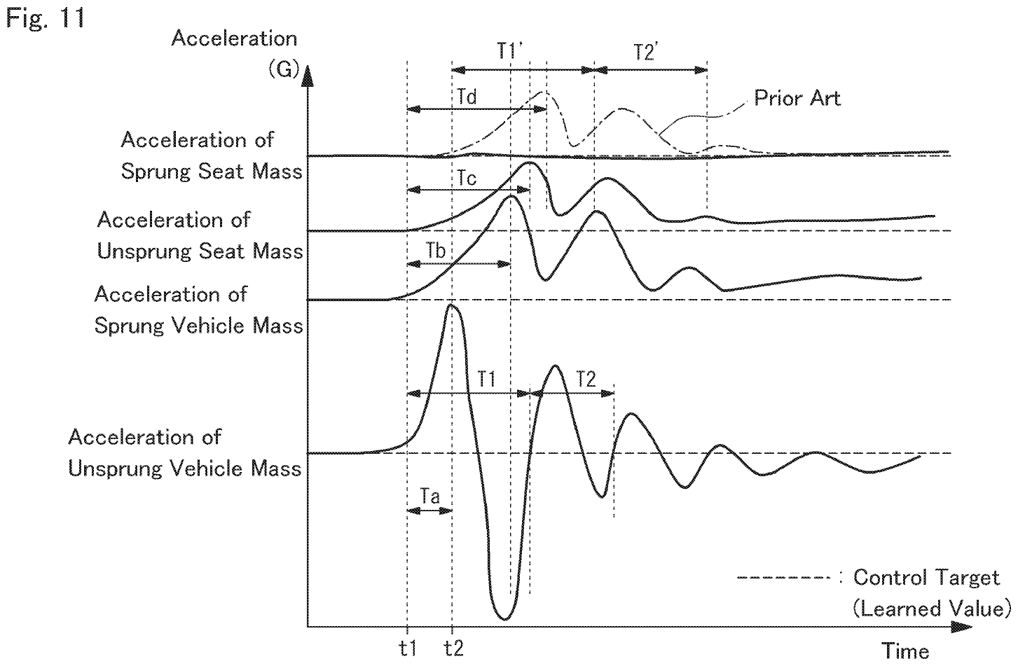

As indicated in FIG. 11, the vibrations (and the acceleration derived from the vibrations) propagating from the tires to the chassis 1 further propagates from the chassis 1 toward the seat 4 with a delay. According to example shown in FIG. 11, the acceleration of the unsprung vehicle mass 8 is generated at point t1, and increased to a first local maximum value at point t2 after the lapse of propagation time Ta. That is, the vibrations inputted to the tires propagate to the unsprung vehicle mass 8 after the lapse of the propagation time Ta. Such vibrations further propagate to the sprung vehicle mass 9 after the lapse of propagation time Tb which is longer than the propagation time Ta, to the unsprung seat mass 10 after the lapse of propagation time Tc which is longer than the propagation time Tb, and to the sprung seat mass 11 after the lapse of propagation time Td which is longer than the propagation time Tc.

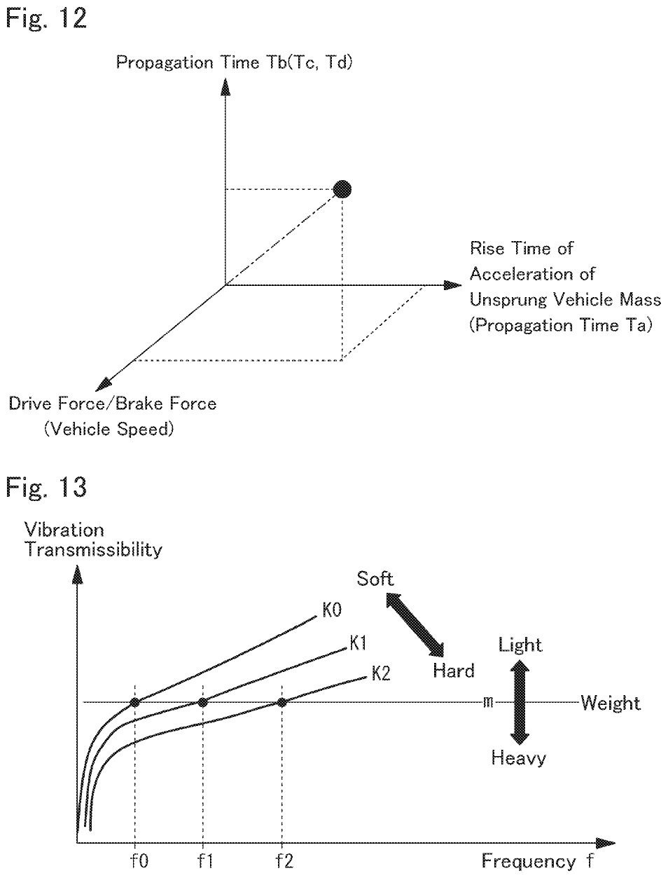

In other words, the propagation time Ta is a rise time of the acceleration of the unsprung vehicle mass 8 from the point t1 at which the acceleration is generated to the point t2 at which the acceleration is increased to the first peak value, and the propagation time Ta may be measured actually together with the acceleration of the unsprung vehicle mass 8. On the other hand, the propagation times Tb, Tc, and Td may be computed based on results of a running test and a simulation. Instead, the propagation times Tb, Tc, and Td may also be determined with reference to a map shown in FIG. 12. Specifically, the map shown in FIG. 12 three-dimensionally determines a relation among: the rise time of the acceleration of the unsprung vehicle mass 8; the drive force or brake force (or vehicle speed); and the propagation times Tb, Tc, and Td.

Based on the propagation time Ta thus computed, cycles of the vibrations propagating to the unsprung vehicle mass 8, that is, fluctuation cycles T1 and T2 of the acceleration of the unsprung vehicle mass 8 shown in FIG. 11 are calculated. Likewise, cycles of the vibrations propagating to the sprung seat mass 11, that is, fluctuation cycles T1′ and T2′ of the acceleration of the sprung seat mass 11 may be calculated based on the propagation time Td. The acceleration and the resonance frequency of the sprung seat mass 11 may be estimated based on the propagation times Ta and Td, the fluctuation cycles T1 and T2, and the fluctuation cycles T1′ and T2′ and so on. For example, the resonance frequency f_{td} may be calculated based on the propagation time Td as expressed by the following equation:

f_{td}=1/td.

Turning back to FIG. 10, at step S4, a target value of the acceleration of the sprung seat mass 11 is calculated based on the estimate values of the acceleration and the resonance frequency of the sprung seat mass 11. Specifically, the target value of the acceleration of the sprung seat mass 11 is set such that the actual (or detection) value of the acceleration of the sprung seat mass 11 is reduced while preventing an occurrence of resonance of the sprung seat mass 11. In addition, the target value of the acceleration of the sprung seat mass 11 is calculated before an actual change in the acceleration of the sprung seat mass 11 is detected, that is, before the vibrations propagate from the unsprung vehicle mass 8 to the sprung seat mass 11.

Then, a (target value of) spring constant k_{tgt} of the air spring 3a, and a (target value of) damping coefficient ζ_{tgt} of the damper 3b are calculated at step S5. Specifically, the spring constant k_{tgt} of the air spring 3a and the damping coefficient ζ_{tgt} of the damper 3b are also set before the vibrations propagate from the unsprung vehicle mass 8 to the sprung seat mass 11.

As shown in FIG. 13, vibration transmission characteristics of the seat suspension 3 are governed by a frequency f of vibrations transmitted from outside the vehicle Ve and a spring constant k of the air spring 3a. The above-mentioned resonance frequency f_{td} is changed in accordance with the spring constant k and a weight of the seat 4 including a weight of the occupant. For example, given that the current spring constant of the air spring 3a is k₂ and that the weight of the seat 4 is m, the resonance frequency f_{td} is f₂. As described, the spring constant k of the air spring 3a is variable so that the resonance frequency f_{td} is changed from f₂ to f₁ by changing the spring constant k of the air spring 3a from k₂ to k₁. Therefore, a target spring constant k_{tgt} is set to a value possible to avoid an occurrence of resonance of the sprung seat mass 11 and to reduce an actual value of the acceleration of the sprung seat mass 11.

The damping coefficient ζ_{tgt} of the damper 3b may be calculated using the following equations. Given that a vertical displacement of the unsprung vehicle mass 8 is “x(t)”, a vertical displacement of the sprung seat mass 11 is “y(t)”, a weight of the seat 4 including a weight of the occupant is “m”, a damping coefficient of the damper 3b is “ζ”, a spring constant k of the air spring 3a is “k”, a motion of the seat suspension 3 may be simply expressed as:

m(d²y(t)/dt²)=−k(y(t)−x(t))−ζ(dy(t)/dt) (1).

Given that a gain of the unsprung seat mass 10 is “α(ω)” and that a delay time of vibration transmission is “φ(ω)”, the above equation (1) may be expressed as:

mα(ω)e^{jφ(ω)}(jω)²e^{jωt}=−kα(ω)e^{jφ(ω)}e^{jωt}+ke^{jωt}−ζα(ω)e^{jφ(ω)}jωe^{jωt} (2).

By solving both sides of the above equation (2), provided that “jω=s”, a transfer function G(s) may be expressed as:

G(s)=ωn²/(s²+2ζωns+ωn²) (3).

The damping coefficient ζ_{tgt} of the damper 3b may be calculated using the above equation (3), based e.g., on the stability assessing method of the Nyquist plot. Specifically, the damping coefficient ζ_{tgt} of the damper 3b is also set to a value possible to avoid an occurrence of resonance of the sprung seat mass 11 and to reduce an actual value of the acceleration of the sprung seat mass 11.

Turning back to FIG. 10, at step S6, the vibration damping control is executed. Specifically, the acceleration of the sprung seat mass 11 is reduced to the target value by the feedback control shown in FIG. 8, using the spring constant k_{tgt} of the air spring 3a and the damping coefficient ζ_{tgt} of the damper 3b calculated at step S5. Thereafter, the routine returns.

Thus, the vibration damping system according to the exemplary embodiment of the present disclosure reduces the vibrations and acceleration of the sprung seat mass 11 by controlling the seat suspension 3. As described, the vibrations propagating from the tires to the chassis 1 through the axle 7 further propagates from the chassis 1 toward the seat 4 with an inevitable delay. According to the exemplary embodiment of the present disclosure, therefore, the vibration damping system is configured to change the spring constant k of the air spring 3a and the damping coefficient ζ of the damper 3b before the vibrations propagate to the sprung seat mass 11. Specifically, the target spring constant k_{tgt} and the target damping coefficient ζ_{tgt} possible to avoid an occurrence of resonance of the sprung seat mass 11 and to reduce acceleration of the sprung seat mass 11 are set before the vibrations propagate to the sprung seat mass 11. For this reason, the vibrations propagating from the tires to the seat 4 can be damped thereby avoiding an occurrence of resonance of the sprung seat mass 11. In this situation, hardness of the vehicle body suspension 2 may be maintained. Therefore, the acceleration of the sprung seat mass 11 resulting from a change in the posture of the vehicle Ve can be reduced while maintaining the vertical load applied to the tire. Thus, according to the exemplary embodiment of the present disclosure, not only ride quality but also controllability and stability of the vehicle Ve can be improved.

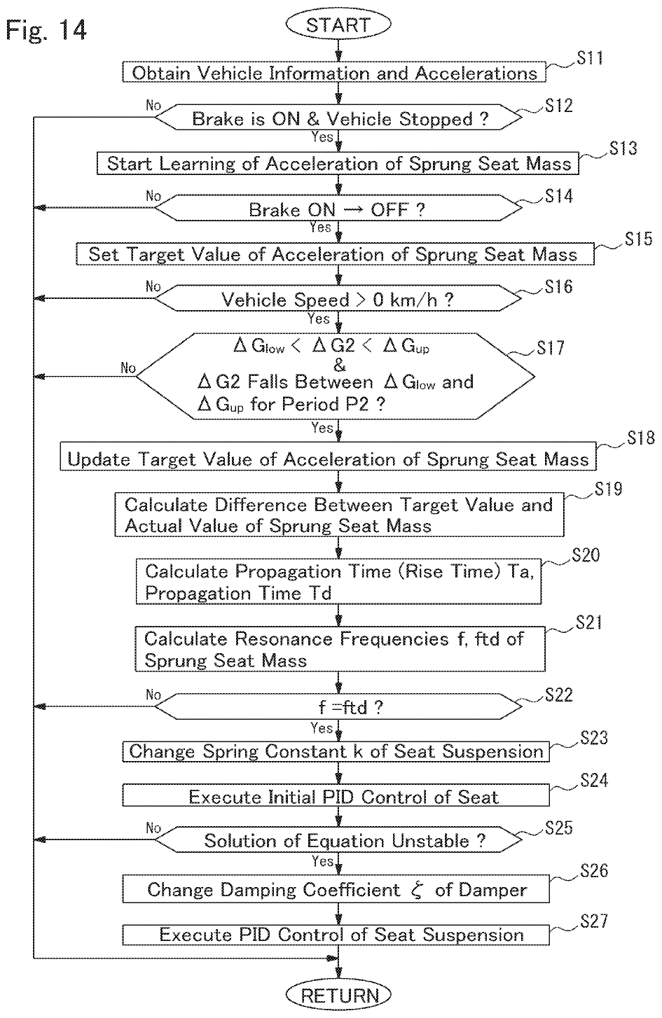

One example of the routine executed by the vibration damping system according to the exemplary embodiment of the present disclosure is shown in FIG. 14 in more detail. At step S11, acceleration of the unsprung vehicle mass 8, acceleration of the sprung vehicle mass 9, acceleration of the unsprung seat mass 10, and acceleration of the sprung seat mass 11 are transmitted to the controller 6 from the acceleration sensors 5a, 5b, 5c, and 5d. In addition, other information detected e.g., by the wheel speed sensor 5h, the accelerator sensor 5i, the brake switch sensor 5j, the brake pressure sensor 5k, the speed sensor 5m, the steering sensor 5n and so on is also transmitted to the controller 6.

Then, it is determined at step S12 whether the vehicle Ve is stopped. Specifically, such determination at step S12 may be made based on a fact that a depression of the brake pedal is detected by the brake switch sensor 5j, and that a speed of the vehicle Ve calculated based on a detection value of the wheel speed sensor 5h is zero.

If the brake pedal is not depressed or the speed of the vehicle Ve is higher than zero so that the answer of step S12 is NO, the routine returns without carrying out any specific control. By contrast, if the brake pedal is depressed and the speed of the vehicle Ve is zero, that is, if the vehicle is stopping so that the answer of step S12 is YES, the routine progresses to step S13 to commence learning of the target value of the acceleration of the sprung seat mass 11.

For example, when the vehicle Ve is stopped, the target value of the acceleration of the sprung seat mass 11 is set to an acceleration of gravity or a predetermined reference value set based on the acceleration of gravity. Then, in order to learn and update the target value of the acceleration of the sprung seat mass 11, a difference ΔG1 between the actual value and the target value of the acceleration of the sprung seat mass 11 is calculated. As explained later, since the difference ΔG1 is calculated in advance at step S13, the difference ΔG1 within a predetermined period of time immediately before the brake force applied to the vehicle Ve is eliminated may be employed to update the target value of the acceleration of the sprung seat mass 11, when eliminating the brake force at after-mentioned step S15. Here, the air spring 20a and the electromagnetic damper 20b of the active body suspension 20 shown in FIG. 7 may also be controlled by the same procedures to control the seat suspension 3.

Then, it is determined at step S14 whether the brake pedal is released to eliminate the bake force applied to the vehicle Ve. If the brake pedal is still depressed so that the answer of step S14 is NO, the routine returns. By contrast, if the brake pedal is returned to an initial position to eliminate the brake force applied to the vehicle Ve so that the answer of step S14 is YES, the routine progresses to step S15 to temporarily fix the target value of the acceleration of the sprung seat mass 11.

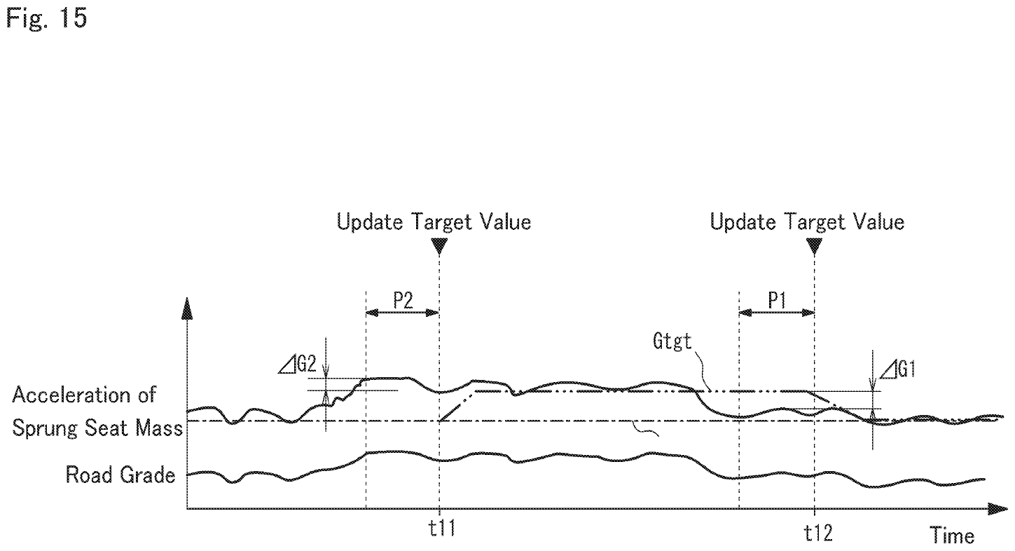

As indicated by the dashed-dotted line in FIG. 15, according to the conventional vibration damping control, a target value of acceleration of a sprung mass is set as a constant value to the acceleration of gravity. Therefore, if the vehicle is stopped on a slope, a detection error of the acceleration may be increased by a change in an action of the acceleration of gravity when eliminating the brake force to launch the vehicle. Consequently, accuracy of the target value of acceleration of a sprung mass may be reduced. In FIG. 15, the aforementioned period of time immediately before the brake force applied to the vehicle Ve is eliminated at point t12 is indicated as the period P1. In order to ensure accuracy of the target value of the acceleration of the sprung seat mass 11, if the difference ΔG1 within the period P1 which has been calculated at step S13 is greater than a predetermined lower limit value but less than a predetermined upper limit value when the vehicle Ve is stopped on a slope, an actual value of the acceleration of the sprung seat mass 11 at point t12 is employed at step S15 as the target value Gtgt of the acceleration of the sprung seat mass 11. That is, the target value Gtgt of the acceleration of the sprung seat mass 11 is temporarily fixed.

Thus, the aforementioned lower limit value and the upper limit value are threshold values use to determine whether the difference ΔG1 between the actual value and the target value of the acceleration of the sprung seat mass 11 affects the vibration damping. To this end, the aforementioned lower limit value and the upper limit value are set based on results of a running test and a simulation. As described, if the difference ΔG1 falls within a range between the lower limit value and the upper limit value, the controller 6 determines that a detection error of the acceleration of the sprung seat mass 11 will be caused. In this case, the target value of the acceleration of the sprung seat mass 11 is updated by the above-explained procedures to eliminate the influence of such detection error. If the difference ΔG1 is less than the lower limit value, the controller 6 determines that the detection error which affects the vibration damping will not be caused. In this case, the target value of the acceleration of the sprung seat mass 11 is updated without changing the current value. By contrast, if the difference ΔG1 is greater than the upper limit value, the detection error exceeds the range between the lower limit value and the upper limit value, and hence the controller 6 determines that the difference ΔG1 will be increased by another factor. In this case, other measures will be taken to reduce the acceleration of the sprung seat mass 11, and the target value of the acceleration of the sprung seat mass 11 is updated without changing the current value.

Thus, when launching the vehicle Ve stopping on a slope by eliminating the brake force, the target value of the acceleration of the sprung seat mass 11 is updated taking account of the detection error of the acceleration of the sprung seat mass 11 caused due to road grade. According to the exemplary embodiment of the present disclosure, therefore, the target value of the acceleration of the sprung seat mass 11 may be set accurately while eliminating the influence of such detection error. For this reason, when launching the vehicle Ve on a slope, the vibrations of the sprung seat mass 11 may be damped effectively to prevent an occurrence of resonance based on the accurate target value, while reducing the acceleration of the sprung seat mass 11 resulting from the change in posture of the vehicle Ve.

Then, it is determined at step S16 whether the vehicle Ve is being propelled. In other words, it is determined whether a speed of the vehicle Ve calculated based on a detection value of the wheel speed sensor 5h is higher than zero. If the speed of the vehicle Ve is zero, that is, if the vehicle Ve is still stopping on the slope so that the answer of step S16 is NO, the routine returns. By contrast, if the speed of the vehicle Ve is higher than zero, that is if the vehicle Ve has already been launched so that the answer of step S16 is YES, the routine progresses to step S17.

At step S17, a difference ΔG2 between the actual value and the target value of the acceleration of the sprung seat mass 11 is calculated. In addition, at step S17, it is determined whether the difference ΔG2 is greater than a predetermined lower limit value ΔG_{low} but less than a predetermined upper limit value ΔGᵤₚ, and whether the difference ΔG2 has fallen continuously within a range between the lower limit value ΔG_{low} and the upper limit value ΔGᵤₚ for a predetermined period of time. The lower limit value ΔG_{low} and the upper limit value ΔGᵤₚ are also threshold values used to determine whether the difference ΔG2 between the actual value and the target value of the acceleration of the sprung seat mass 11 affects the vibration damping. To this end, the lower limit value ΔG_{low} and the upper limit value ΔGᵤₚ may also be set based on results of a running test and a simulation. However, the lower limit value ΔG_{low} and the upper limit value ΔGᵤₚ may also be set to same values as the aforementioned lower limit value and the upper limit value employed at step S15. Instead, since the vehicle Ve is propelled in this case, the lower limit value ΔG_{low} and the upper limit value ΔGᵤₚ may also be set to different values from the aforementioned lower limit value and the upper limit value employed at step S15.

At step S17, if the difference ΔG2 falls within a range between the lower limit value ΔG_{low} and the upper limit value ΔGᵤₚ, the controller 6 determines that a detection error of the acceleration of the sprung seat mass 11 which affects the vibration damping is caused. In this case, the target value of the acceleration of the sprung seat mass 11 is updated at after-mentioned step S18 to eliminate the influence of such detection error. If the difference ΔG2 is less than the lower limit value ΔG_{low}, the controller 6 determines that the detection error which affects the vibration damping is not caused. By contrast, if the difference ΔG2 is greater than the upper limit value ΔGᵤₚ, the detection error exceeds the range between the lower limit value ΔG_{low} and the upper limit value ΔGᵤₚ, and hence the controller 6 determines that the difference ΔG2 is increased by another factor. In this case, other measures will be taken to reduce the acceleration of the sprung seat mass 11.

If at least any one of the above-mentioned conditions is/are not satisfied so that the answer of step S16 is NO, the routine returns. By contrast, if the difference ΔG2 is greater than the predetermined lower limit value ΔG_{low} but less than the predetermined upper limit value ΔGᵤₚ, and the difference ΔG2 has fallen continuously within the range between the lower limit value ΔG_{low} and upper limit value ΔGᵤₚ for the predetermined period of time so that the answer of step S17 is YES, the routine progresses to step S18. Here, the vibrations of the sprung seat mass 11 can be damped more effectively and accurately by executing the vibration damping control during cruising. Therefore, at step S17, it may also be determined whether the vehicle Ve is running at a constant speed. In addition, the influence of the detection error of the acceleration is increased with an increase in a road grade. Therefore, at step S17, it may also be determined whether a road grade detected by a road grade sensor (not shown) is greater than a predetermined value.

At step S18, the target value of the acceleration of the sprung seat mass 11 is updated. As indicated by the dashed-dotted line in FIG. 15, according to the conventional vibration damping control, a target value of acceleration of a sprung mass is set as a constant value to the acceleration of gravity. Therefore, a detection error of the acceleration may be increased by a change in an action of the acceleration of gravity during propulsion on a slope. Consequently, accuracy of the target value of acceleration of a sprung mass may be reduced. In FIG. 15, the aforementioned period of time in which the difference ΔG2 falls continuously within the range between the lower limit value ΔG_{low} and upper limit value ΔGᵤₚ is indicated as the period P2. In the case that the answer of step S17 is YES during propulsion on a slope, the target value Gtgt of the acceleration of the sprung seat mass 11 is updated at step S18 to an actual value of the acceleration of the sprung seat mass 11 at point t11 after the lapse of the period P2.

Thus, when launching the vehicle Ve stopping on a slope, the target value of the acceleration of the sprung seat mass 11 is updated taking account of the detection error of the acceleration of the sprung seat mass 11 caused due to road grade. According to the exemplary embodiment of the present disclosure, therefore, the target value of the acceleration of the sprung seat mass 11 may be set accurately while eliminating the influence of such detection error. For this reason, when launching the vehicle Ve on a slope, the vibrations of the sprung seat mass 11 may be damped effectively to prevent an occurrence of resonance based on the accurate target value, while reducing the acceleration of the sprung seat mass 11 resulting from change in posture of the vehicle Ve.

Then, a feedback control (i.e., a PID control) will be executed to achieve the target value of the acceleration of the sprung seat mass 11 thus updated. In order to achieve the target value of the acceleration of the sprung seat mass 11, the spring constant k of the air spring 3a and the damping coefficient ζ of the damper 3b are set before the vibrations propagate to the sprung seat mass 11.

Specifically, in order to execute the feedback control, a difference between the target value and the actual value of the acceleration of the sprung seat mass 11 is calculated at step S19. Here, the air spring 20a and the electromagnetic damper 20b of the active body suspension 20 shown in FIG. 7 may also be controlled by the same procedures as the feedback control of the seat suspension 3.

At step S20, a propagation time Td is calculated. As described, for example, the propagation time Td may be calculated based on the rise time (i.e., the propagation time) Ta of the vibrations inputted to the tires with reference to the map shown in FIG. 12.

At step S21, a resonance frequency f and a resonance frequency f_{td} of the sprung seat mass 11 are calculated. Specifically, the resonance frequency f may be calculated based on the current spring constant k of the air spring 3a with reference to the vibration transmission characteristics of the seat suspension 3 shown in FIG. 13. On the other hand, the resonance frequency f_{td} is an estimate value based on the target value of the acceleration of the sprung seat mass 11, and as described, the resonance frequency f_{td} is calculated as an inverse number of the propagation time Td.

Then, it is determined at step S22 whether the resonance frequency f and the resonance frequency f_{td} are identical to each other. That is, it is determined whether the resonance frequency f_{td} estimated based on the target value of the acceleration of the sprung seat mass 11 is identical to the resonance frequency f estimated based on the current spring constant k of the air spring 3a.

If the resonance frequency f_{td} and the resonance frequency f are identical to each other so that the answer of step S22 is YES, the routine progresses to step S23. In this case, resonance is expected to occur and the vibrations may not be damped effectively with the current spring constant k of the air spring 3a and the current damping coefficient ζ of the damper 3b. Therefore, the spring constant k of the air spring 3a and the damping coefficient ζ of the damper 3b will be changed at the following steps.

At step S23, the spring constant k of the air spring 3a is changed with reference to the vibration transmission characteristics of the seat suspension 3 shown in FIG. 13. According to the example shown in FIG. 13, the spring constant k of the air spring 3a is changed from k₂ to k₁.

At step S24, an initial PID control of the seat suspension 3 is executed. During the initial PID control, specifically, the feedback control of the target acceleration of the sprung seat mass 11 is executed based on the current spring constant k, the current damping coefficient ζ, and the information predicted by the laser sensor 5o and the navigation system 5p. If the information necessary to damp the vibrations has not yet been predicted by the laser sensor 5o and the navigation system 5p, or the vehicle Ve is not provided with the laser sensor 5o and the navigation system 5p, step S24 may be skipped.

Then, at step S25, an equation of motion of the seat suspension 3 is obtained, and it is determined whether a solution of the equation of motion is “unstable”. For example, it is determined whether the transfer function G(s) expressed by the above-mentioned equation (3) is assessed as “unstable” based on the Nyquist stability criterion. That is, it is determined whether the solution of the equation of motion is unstable by assigning the current spring constant k and the current damping coefficient ζ. In short, at step S24, it is determined whether the seat suspension 3 in which the current damping coefficient ζ is set functions properly to damp the vibrations.

If the solution of the equation of motion is unstable so that the answer of step S25 is YES, the controller 6 predicts that the seat suspension 3 will not function properly to damp the vibration, and the routine progresses to step S26.

In this case, therefore, the damping coefficient ζ of the damper 3b is changed at step S26. For example, the damping coefficient ζ is changed to a value at which the transfer function G(s) expressed by the above-mentioned equation (3) may be assessed as “stable” based on the Nyquist stability criterion. Optionally, the spring constant k and the damping coefficient ζ may be changed linearly to the values at which the transfer function G(s) may be assessed as “stable”.

Then, at step S27, the PID control of the seat suspension 3 is executed. Specifically, the feedback control of the target acceleration of the sprung seat mass 11 is executed based on the current spring constant k and the current damping coefficient ζ thus calculated. Thereafter, the routine returns.

The above-mentioned steps S23 to S27 may be executed repeatedly until the propagation time (i.e., the rise time) Ta of the vibrations is increased to a predetermined maximum value. For example, the maximum value of the propagation time Ta may be set based on results of a running test and a simulation.

By contrast, if the resonance frequency f_{td} and the resonance frequency f are not identical to each other, the answer of step S22 will be NO. In this case, an occurrence of the resonance of the sprung seat mass 11 can be prevented by the seat suspension 3 in which the spring constant k of the air spring 3a has been changed. Therefore, the routine returns.

Likewise, if the solution of the equation of motion is stable so that the answer of step S25 is NO, the controller 6 determines that the seat suspension 3 in which the damping coefficient ζ of the damper 3b has been changed will function properly to damp the vibration. In this case, therefore, the routine also returns.

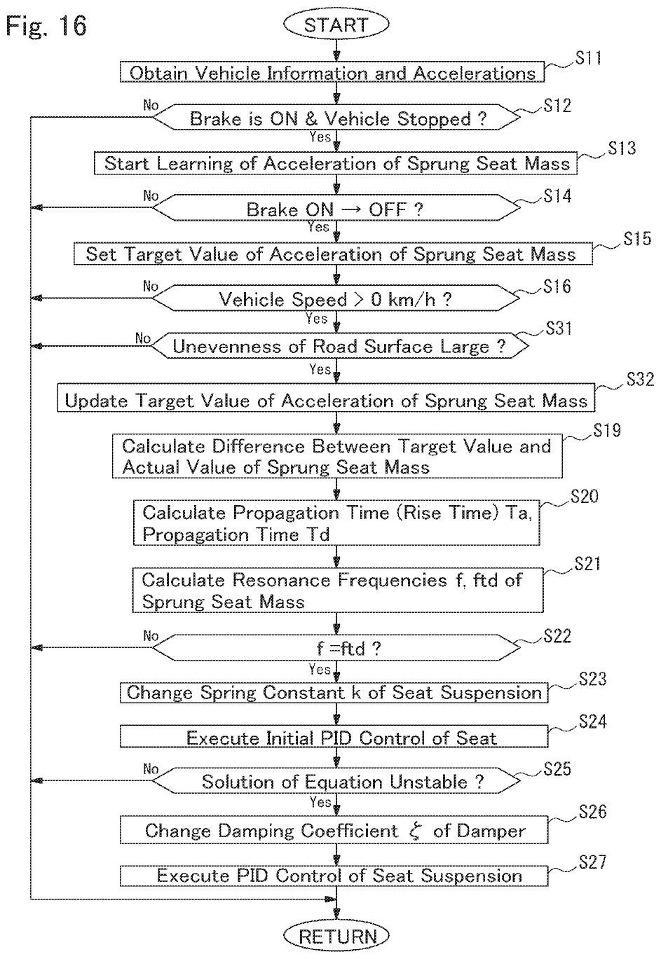

Turning to FIG. 16, there is shown another example of the routine executed by the vibration damping system according to the exemplary embodiment of the present disclosure. In the routine shown in FIG. 16, steps S31 and S32 are executed instead of steps S17 and S18 of the routine shown in FIG. 14. Instead, the routine shown in FIG. 16 may be executed simultaneously or consecutively with the routine shown in FIG. 14. In FIG. 16, common step numbers are allotted to the steps in common with those in the routine shown in FIG. 14.

In the routine shown in FIG. 16, if the vehicle Ve has already been launched so that the answer of step S16 is YES, the routine progresses to step S31 to determine whether unevenness of the road surface is large.

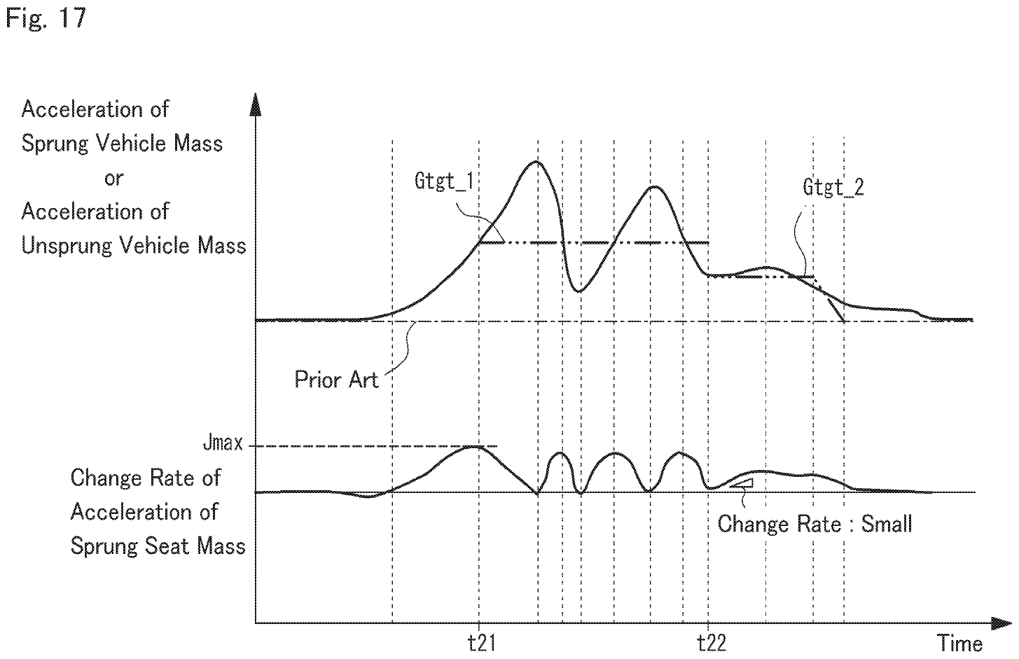

For example, at step S31, it is determined whether an estimate value of an amplitude of vibrations generating the acceleration of the unsprung vehicle mass 8 or the sprung vehicle mass 9 is greater than a predetermined amplitude as indicated in FIG. 17. Instead, a difference in height of the road surface obtained through the laser sensor 5o or the navigation system 5p is greater than a predetermined length.

The aforementioned predetermined amplitude and predetermined length are threshold values use to determine whether the unevenness of the road surface affects the vibration damping. To this end, the predetermined amplitude and predetermined length are set based on results of a running test and a simulation. If the estimate value of the amplitude of vibrations generating the acceleration of the unsprung vehicle mass 8 or the sprung vehicle mass 9 is greater than the predetermined amplitude, or if difference in height of the road surface is greater than the predetermined length, the controller 6 determines that a detection error which affects the vibration damping will be caused due to unevenness of the road surface.

If the unevenness of the road surface is not large, specifically, if the estimate value of the amplitude of vibrations is less than the predetermined amplitude, or if the difference in height of the road surface is less than the predetermined length so that the answer of step S31 is NO, the controller 6 determines that the vehicle Ve is not running on a rough road which affects the vibration damping. In this case, therefore, the routine returns. By contrast, if the unevenness of the road surface is large, specifically, if the estimate value of the amplitude of vibrations is greater than the predetermined amplitude, or if the difference in height of the road surface is greater than the predetermined length so that the answer of step S31 is YES, the routine progresses to step S32 to update the target value of the acceleration of the sprung seat mass 11.

For example, if the unevenness of the road surface is large and the acceleration of the unsprung vehicle mass or the sprung vehicle mass is changed significantly, according to the conventional vibration damping control, a target value of acceleration of the unsprung vehicle mass or the sprung vehicle mass may not follow an actual change in the acceleration. According to the conventional vibration damping control, therefore, a target value of acceleration of the unsprung vehicle mass or the sprung vehicle mass is set to a constant value as indicated by the dashed-dotted line in FIG. 17, and a detection error of the acceleration will be increased. In order not to increase the detection error of the acceleration during propulsion on a rough road, at step S32, a change rate of the acceleration of the sprung seat mass 11 and a local maximum value of the change rate of the acceleration of the sprung seat mass 11 are calculated. In addition, the target value of the acceleration of the sprung seat mass 11 is updated to an estimate value of the acceleration of the unsprung vehicle mass 8 or the sprung vehicle mass 9 at a time point corresponding to a time point at which the change rate of the acceleration of the sprung seat mass 11 is increased to the local maximum value.

Specifically, as shown in FIG. 17, a change rate of the acceleration of the sprung seat mass 11 is estimated, and a local maximum value Jₘₐₓ of the change rate of the acceleration of the sprung seat mass 11 is computed. At the same time, time point t21 at which the change rate of the acceleration of the sprung seat mass 11 is increased to the local maximum value Jₘₐₓ is determined. Further, an estimate value Gₑₛₜ of the acceleration of the unsprung vehicle mass 8 or the sprung vehicle mass 9 at point t21 is obtained, and the estimate value Gₑₛₜ is employed as a target value G_{tgt_1} of the acceleration of the sprung seat mass 11.

However, when the unevenness of the road surface is reduced after point t22 so that a fluctuation of the acceleration of the unsprung vehicle mass 8 or the sprung vehicle mass 9 is reduced, the target value of the acceleration of the sprung seat mass 11 may be set erroneously. In this situation, therefore, the target value of the acceleration of the sprung seat mass 11 may be further updated to a new value. For example, when the change rate of the acceleration of the sprung seat mass 11 becomes less than a predetermined value at point t22, the estimate value of the acceleration of the unsprung vehicle mass 8 or the sprung vehicle mass 9 at point t22 may be employed as a target value G_{tgt_2} of the acceleration of the sprung seat mass 11.

After updating the target value of the acceleration of the sprung seat mass 11 at step S32, the routine progresses to step S19 to execute the controls of subsequent steps.

As explained above, when the vehicle Ve travels on a bumpy road and the tires bounce on the road surface intermittently, the acceleration of the unsprung vehicle mass 8 or the sprung vehicle mass 9 is fluctuated significantly and the detection values of the acceleration will be varied significantly. In this situation, therefore, the target value of the acceleration of the sprung seat mass 11 may not be set accurately and the vibrations may not be damped effectively. In order to avoid such disadvantage, according to the exemplary embodiment of the present disclosure, the estimate value Gₑₛₜ of the acceleration of the unsprung vehicle mass 8 or the sprung vehicle mass 9 at point t21 when the change rate of the acceleration of the sprung seat mass 11 is increased to the local maximum value Jₘₐₓ is employed as the target value G_{tgt_1} of the acceleration of the sprung seat mass 11. Consequently, the target value G_{tgt_1} of the acceleration of the sprung seat mass 11 may be set accurately based on the estimate value Gₑₛₜ of e.g., the sprung vehicle mass 9 which is estimated accurately while eliminating the influence of detection error. According to the exemplary embodiment of the present disclosure, therefore, the vibrations of the sprung seat mass 11 can be damped effectively while preventing an occurrence of resonance by controlling the acceleration of the sprung seat mass 11 based on the target value G_{tgt_1}, even when the vehicle Ve travels on a rough road.

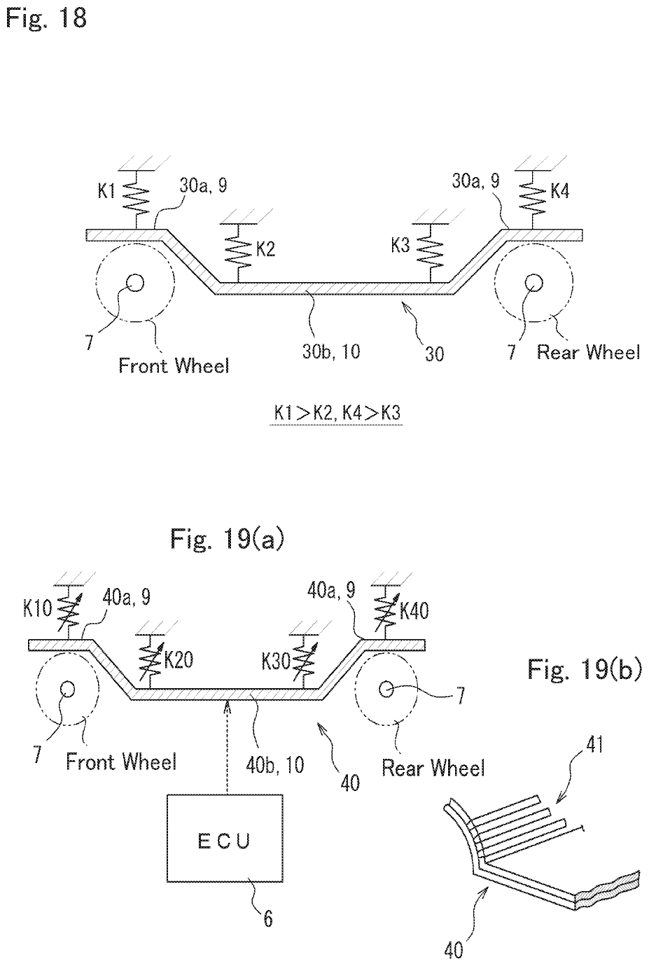

The vibration damping system according to the exemplary embodiment of the present disclosure may also be applied to the vehicle Ve having chassis shown in FIGS. 18 and 19a-19b.

A chassis 30 shown in FIG. 18 comprises an axle supporting section 30a and an underbody section 30b. Specifically, the axle supporting section 30a as the sprung vehicle mass 9 supports the axle 7 through a vehicle suspension (not shown), and the underbody section 30b as the unsprung seat mass 10 supports the seat 4 through the seat suspension 3.

In the chassis 30, first chassis spring constants K1 and K4 of elastic members of the axle supporting section 30a are greater than second chassis spring constants K2 and K3 of elastic members of the underbody section 30b, respectively. That is, in the chassis 30, elastic rigidity of the axle supporting section 30a is higher than elastic rigidity of the underbody section 30b. In FIG. 18, the elastic members of the axle supporting section 30a and the underbody section 30b are also illustrated schematically as a vibration model for the sake of explanation.

Specifically, the first chassis spring constant K1 is a spring constant of the elastic member of the front axle supporting section 30a, and the first chassis spring constant K4 is a spring constant of the elastic member of the rear axle supporting section 30a. On the other hand, the second chassis spring constant K2 is a spring constant of the elastic member of the front underbody section 30b, and the second chassis spring constants K3 is a spring constant of the elastic member of the rear underbody section 30b.

Thus, the rigidity of the axle supporting section 30a is higher than the rigidity of the underbody section 30b so that vertical load applied to the tire is ensured to improve controllability and stability of the vehicle Ve. In addition, the vibrations propagating to the sprung seat mass 11 may be further delayed so that the vibration damping effect is improved to further improve ride quality of the vehicle Ve.

A chassis 40 shown in FIG. 19a comprises an axle supporting section 40a and an underbody section 40b. Specifically, the axle supporting section 40a as the sprung vehicle mass 9 supports the axle 7 through a vehicle suspension (not shown), and the underbody section 40b as the unsprung seat mass 10 supports the seat 4 through the seat suspension 3.

In the chassis 40, first chassis spring constants K10 and K40 of elastic members of the axle supporting section 40a, and second chassis spring constants K20 and K30 of elastic members of the underbody section 30b are variable, respectively. That is, in the chassis 40, elastic rigidity of the axle supporting section 40a and elastic rigidity of the underbody section 40b may be changed by changing the first chassis spring constants K10 and K40 and the second chassis spring constants K20 and K30. In FIG. 19a, the elastic members of the axle supporting section 40a and the underbody section 40b are also illustrated schematically as a vibration model for the sake of explanation.

Specifically, the first chassis spring constant K10 is a spring constant of the elastic member of the front axle supporting section 40a, and the first chassis spring constant K40 is a spring constant of the elastic member of the rear axle supporting section 40a. On the other hand, the second chassis spring constant K20 is a spring constant of the elastic member of the front underbody section 40b, and the second chassis spring constants K30 is a spring constant of the elastic member of the rear underbody section 40b.

In the chassis 40, the elastic rigidities of the axle supporting section 40a and the underbody section 40b are individually controlled by the controller in such a manner as to reduce an actual value of the acceleration of the sprung seat mass 11.

To this end, in the example shown in FIG. 19b, magnetic fluid 41 is buried in each of the axle supporting section 40a and the underbody section 40b. In the chassis 40, therefore, the elastic rigidities of the axle supporting section 40a and the underbody section 40b may be controlled electrically by controlling condition (i.e., rigidity) of the magnetic fluid 41 buried in the axle supporting section 40a and the underbody section 40b using an electric magnet.

In the vehicle Ve having the chassis 40, the rigidity of the axle supporting section 40a is set higher than the rigidity of the underbody section 40b during normal propulsion. During normal propulsion, therefore, controllability and stability of the vehicle Ve can be improved while improving ride quality. When the running condition of the vehicle Ve is changed, the rigidities of the axle supporting section 40a and the underbody section 40b may be changed arbitrarily in such a manner as to damp the vibrations effectively.

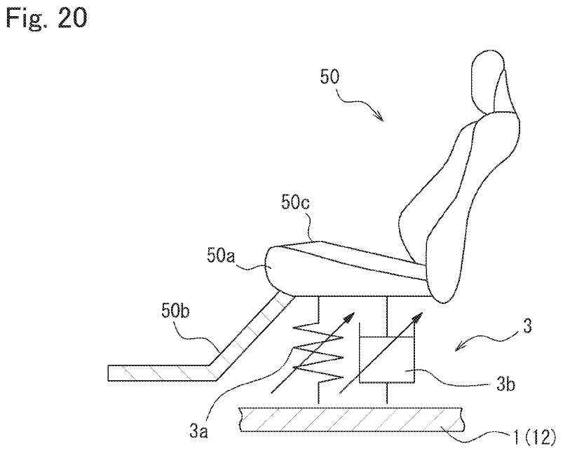

Turning to FIG. 20, there is shown another example of the structure of the seat of the vehicle Ve. A seat 50 shown in FIG. 20 comprises a seat base 50a, a footrest 50b on which feet of the occupant rest, and a seat surface 50c on which the occupant sits. In the seat 50, the vibrations propagating to the seat base 50a and the footrest 50b are damped.

Specifically, the footrest 50b is integrated with the seat base 50a, and the seat 50 is supported by the chassis 1 (or the floor member 12) through the seat suspension 3. That is, the footrest 50b and the seat base 50a are moved integrally above the seat suspension 3 to damp the vibrations propagating thereto.

Optionally, given that the seat 50 is employed as a driver seat, the accelerator pedal and the brake pedal as well as supporting members thereof (neither of which are shown) may be integrated with the footrest 50b. In this case, the vibrations propagating to those pedals may also be damped by controlling the seat suspension 3 in accordance with operations of those pedals.

Thus, in a case of employing the seat 50 in the vehicle Ve, the vibrations propagating to the feet of the occupant may also be damped.

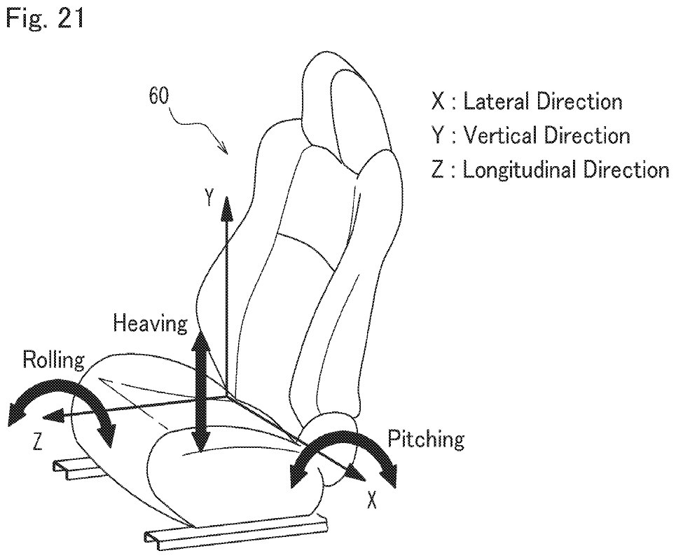

The vibration damping system according to the exemplary embodiment of the present disclosure may also be applied to the vehicle Ve having a seat 60 shown in FIG. 21. Specifically, the seat 60 is a conventional electric-powered seat, and a position thereof, an inclination of a backrest etc. may be adjusted by a seat motor (not shown).

For example, the seat/suspension controller 6a actuate the seat motor based on a detection value transmitted from the steering sensor 5n to adjust the seat 60 in such a manner as to suppress the acceleration of the sprung seat mass 11. Specifically, the acceleration of the sprung seat mass 11 resulting from pitching of the vehicle Ve may be suppressed by controlling the seat 60 based on detection values transmitted to the seat/suspension controller 6a from the accelerator sensor 5i and the brake pressure sensor 5k. In addition, the acceleration of the sprung seat mass 11 resulting from rolling and pitching of the vehicle Ve, and the acceleration of the sprung seat mass 11 resulting from heaving (or bouncing) of the vehicle Ve may also be suppressed by controlling the seat 60 based on detection values transmitted to the seat/suspension controller 6a from the steering sensor 5n, the accelerator sensor 5i, the brake pressure sensor 5k and so on.

Thus, in a case of employing the seat 60 in the vehicle Ve, the vibrations propagating to the seat 60 may be damped effectively by controlling the seat motor.

Although the above exemplary embodiments of the present disclosure have been described, it will be understood by those skilled in the art that the present disclosure should not be limited to the described exemplary embodiments, and various changes and modifications can be made within the scope of the present disclosure.

What is claimed is:

1. A vibration damping system for a vehicle comprising:
a vehicle body suspension that absorbs and damps vibrations propagating between an axle and a chassis of the vehicle;
a seat suspension including a spring and a damper that absorb and damp vibrations propagating between the chassis and a seat, in which a spring constant of the spring and a damping coefficient of the damper are variable; and
a detector that obtains information relating to a running condition of the vehicle,
the vibration damping control system comprising:
a controller that controls the seat suspension based on the information obtained by the detector,
wherein the information obtained by detector includes:
an acceleration of an unsprung vehicle mass below the vehicle body suspension;
an acceleration of a sprung vehicle mass above the vehicle body suspension;
an acceleration of an unsprung seat mass below the seat suspension; and
an acceleration of a sprung seat mass above the seat suspension, and
the controller is configured to:
estimate the acceleration of the sprung seat mass and a resonance frequency when the vibrations resulting from change in the acceleration of the unsprung vehicle mass propagates to the sprung seat mass via the sprung vehicle mass and the unsprung seat mass, based on the information obtained by the detector;
calculate a target value of the acceleration of the sprung seat mass possible to reduce an actual value of the acceleration of the sprung seat mass while preventing an occurrence of resonance, by changing the estimate values of the acceleration of the sprung seat mass; and
set the spring constant of the spring and the damping coefficient of the damper to values possible to achieve the target value of the acceleration of the sprung seat mass, before the vibrations propagate to the sprung seat mass.

2. The vibration damping system for the vehicle as claimed in claim 1, wherein the controller is further configured to:
calculate a change rate of the acceleration of the sprung seat mass and a local maximum value of the change rate of the acceleration of the sprung seat mass; and
update the target value of the acceleration of the sprung seat mass to an estimate value of the acceleration of the sprung seat mass at a time point when the change rate of the acceleration of the sprung seat mass is increased to the local maximum value.

3. The vibration damping system for the vehicle as claimed in claim 1, wherein the controller is further configured to:
calculate a difference between the actual value and the target value of the acceleration of the sprung seat mass during propulsion of the vehicle;
determine whether the difference between the actual value and the target value of the acceleration of the sprung seat mass is greater than a predetermined lower limit value but less than a predetermined upper limit value, and whether the difference between the actual value and the target value of the acceleration of the sprung seat mass has fallen continuously within a range between the predetermined lower limit value and the predetermined upper limit value for a predetermined period of time; and
update the target value of the acceleration of the sprung seat mass to the actual value of the acceleration of the sprung seat mass at an end point of the predetermined period of time, if the difference between the actual value and the target value of the acceleration of the sprung seat mass has fallen continuously within the range between the predetermined lower limit value and the predetermined upper limit value for the predetermined period of time.

4. The vibration damping system for the vehicle as claimed in claim 1, wherein the controller is further configured to:
calculate a difference between the actual value and the target value of the acceleration of the sprung seat mass while the vehicle is stopping;
determine whether the difference between the actual value and the target value of the acceleration of the sprung seat mass calculated within a predetermined period of time immediately before cancelling a brake force applied to the vehicle is greater than a predetermined lower limit value but less than a predetermined upper limit value; and
update the target value of the acceleration of the sprung seat mass to the actual value of the acceleration of the sprung seat mass at a point when the brake force applied to the vehicle is eliminated, if the difference between the actual value and the target value of the acceleration of the sprung seat mass calculated within the predetermined period of time is greater than the predetermined lower limit value but less than the predetermined upper limit value.

5. The vibration damping system for the vehicle as claimed in claim 1,
wherein the vehicle comprises a plurality of the separated seats,
the chassis includes the sprung vehicle mass and the unsprung seat mass,
the seat suspension is arranged individually between the chassis and each of the seats, and
the controller is further configured to control each of the seat suspension individually.

6. The vibration damping system for the vehicle as claimed in claim 1,
wherein the vehicle comprises a plurality of the separated seats, and a floor member to which the seats are fixed,
the chassis includes the sprung vehicle mass and the unsprung seat mass, and
the seat suspension is arranged between the chassis and the floor member.

7. The vibration damping system for the vehicle as claimed in claim 5,
wherein the chassis comprises:
an axle supporting section as the sprung vehicle mass that supports the axle through the vehicle body suspension; and
an underbody section as the unsprung seat mass that supports the seat through the seat suspension, and
a first chassis spring constant of an elastic member of the axle supporting section is greater than a second chassis spring constant of an elastic member of the underbody section.

8. The vibration damping system for the vehicle as claimed in claim 5,
wherein the chassis comprises:
an axle supporting section as the sprung vehicle mass that supports the axle through the vehicle body suspension; and
an underbody section as the unsprung seat mass that supports the seat through the seat suspension,
rigidities of the axle supporting section and the underbody section may be changed respectively by changing a first chassis spring constant of an elastic member of the axle supporting section and a second chassis spring constant of an elastic member of the underbody section, and
the controller is further configured to control the rigidities of the axle supporting section and the underbody section such that the actual value of the acceleration of the sprung seat mass is reduced.

9. The vibration damping system for the vehicle as claimed in claim 1,
wherein the seat suspension comprises a pair of the springs arranged in a lateral direction of the vehicle,
the detector is configured to detect a displacement or vibrations of the vehicle in a rolling direction, and
the controller is further configured to control each of the springs individually to suppress the displacement or vibrations of the vehicle in the rolling direction.

10. The vibration damping system for the vehicle as claimed in claim 1,
wherein the seat suspension comprises a pair of the springs arranged in a longitudinal direction of the vehicle,
the detector is configured to detect a displacement or vibrations of the vehicle in a pitching direction, and
the controller is further configured to control each of the springs individually to suppress the displacement or vibrations of the vehicle in the pitching direction.
